(19) United States
(12) Patent Application Publication
(10) Pub. No.: US 2013/0037655 A1
(43) Pub. Date: Feb. 14, 2013

(54) METHOD OF SEALING A GAP

(71) Applicants: Jeremy Bradley, Bristol (GB); Colin John West, Pontypridd (GB)

(72) Inventors: Jeremy Bradley, Bristol (GB); Colin John West, Pontypridd (GB)

(73) Assignee: AIRBUS OPERATIONS LIMITED, Bristol (GB)

(21) Appl. No.: 13/642,588

(22) PCT Filed: May 24, 2011
(86) PCT No.: PCT/GB11/50973

§ 371 Date: Oct. 22, 2012

(30) Foreign Application Priority Data
May 27, 2010 (GB) 1008863.1

(51) Int. Cl. B64C 3/00; F16J 15/02

(52) U.S. Cl. 244/124; 277/312; 277/637

(57) ABSTRACT

A method of sealing a gap between first and second aerodynamic surfaces. The width of the gap between the two surfaces is measured to obtain a gap measurement. The width of a seal member is pre-formed in accordance with the gap measurement. The seal member is fitted into the gap such that the seal member is substantially flush with the first and second aerodynamic surfaces. Apparatus for performing the method is also described. The apparatus comprising: a metrology device adapted to measure the width of the gap between the first and second aerodynamic surfaces; a seal member dispenser for dispensing a seal member; and a cutter adapted to cut the seal member to size in accordance with the measurements obtained by the metrology device.

### FIELD OF THE INVENTION

The present invention relates to a method and related apparatus for sealing a gap between first and second aerodynamic surfaces, and an aerodynamic assembly.

### BACKGROUND OF THE INVENTION

The external aerodynamic surface of an aircraft wing is typically formed by joining together separately formed panels. Particularly if these panels are formed from a composite material, such as carbon fibre reinforced plastic (CFRP), a gap will be present between the adjacent aerodynamic surfaces due to tolerances in the panel manufacturing process. Such a gap will cause turbulence when the aircraft is in use, decreasing its aerodynamic efficiency.

The width of the gap cannot be predicted accurately, and may vary along its length, so a pre-fabricated seal of predetermined and constant width will not accurately seal the gap.

A conventional method of sealing such gaps is to manually tool into place a liquid sealant material to form a smooth fillet. However, the process is subject to human error. Moreover liquid sealant materials typically exhibit a degree of shrinkage during cure which gives the fillet a concave aerodynamic surface. These factors limit the improvement in aerodynamic efficiency that can be achieved by this method.

The fillets are typically overpainted, but the mismatch in elasticity between the paint and sealant layers often results in cracking of the paint surface during flex of the aircraft. This results in undesirable cosmetic damage, steps and gaps.

The above limitations are undesirable on turbulent flow wing designs and unacceptable on laminar flow wing designs. Therefore, an alternative method of sealing such gaps is required which can account for the unpredictable width of the gap.

### SUMMARY OF THE INVENTION

A first aspect of the invention provides a method of sealing a gap between first and second aerodynamic surfaces, the method comprising: measuring the width of the gap between the two surfaces to obtain a gap measurement; pre-forming the width of a seal member in accordance with the gap measurement; and fitting the seal member into the gap such that the seal member is substantially flush with the first and second aerodynamic surfaces.

Measuring the gap and pre-forming the width of the seal member accordingly enables alternative sealing materials to be used which do not suffer from the problems of shrinkage and/or elasticity mismatch experienced by conventional liquid sealing materials.

Preferably the width of the gap is measured at a plurality of positions along its length and the width of the seal member is formed accordingly. Thus the seal member can be formed with a width which varies along its length to seal the gap accurately.

Preferably the method further comprises: forming a recess in a corner where a first one of the aerodynamic surfaces meets the gap, the recess having a seat which is inset relative to the first one of the aerodynamic surfaces; and engaging the seal member with the seat. In the case of a scarf joint, only a single recess may be formed, but in other cases a second recess may be formed in a corner where a second one of the aerodynamic surfaces meets the gap, the second recess having a second seat which is inset relative to the second one of the aerodynamic surfaces; and the seal member engaged with the second seat.

The seal member may be bonded to the seat(s) with an adhesive. The adhesive may be carried by the seal member, or may be applied to the seat(s) before the seal member is fitted.

The seal member may comprise a curable material, such as epoxy resin or PEEK (polyaryletheretherketone), which is at least partially cured before sealing the gap.

The width of the seal member may be pre-formed by moulding, or by removing material from the sealing member, for example by cutting or machining.

Measurement of the gap, pre-forming of the seal member; and fitting of the seal may be performed as distinct steps. That is the width of the entire length of the gap may be measured in a first step, then the entire length of the seal member pre-formed as a second step, then the seal member fitted as a third step. However more preferably two or more of these processes are run at the same time at different positions along the length of the gap. For instance each part of the seal member may be fitted immediately after it has been pre-formed. For example the seal member may be cut to size in accordance with the gap measurement as it is fed from a roll and fitted into the gap.

A second aspect of the invention provides apparatus for performing the method of the first aspect of the invention, the apparatus comprising: a metrology device adapted to measure the width of the gap between the first and second aerodynamic surfaces; a seal member dispenser for dispensing a seal member; and a cutter adapted to cut the seal member to size in accordance with the measurements obtained by the metrology device. Preferably the metrology device, dispenser and cutter are integrated into a single tool and can thus be moved together along the length of the gap.

A further aspect of the invention provides an aerodynamic assembly comprising: first and second components with respective first and second aerodynamic surfaces, the first and second components having opposed edges; a gap between the first and second aerodynamic surfaces; and a seal member which extends between the aerodynamic surfaces to seal the gap and is substantially flush with the aerodynamic surfaces, wherein at least one of the components has a recess which is formed in a corner where a respective one of the aerodynamic surfaces meets a respective one of the opposed edges, the recess having a seat which is inset relative to its respective aerodynamic surface and engages the seal member; and wherein the width of the gap varies along its length and the width of the seal member varies accordingly.

Preferably the (or each) seat is substantially parallel with its respective aerodynamic surface.

The components may be coupled to each other by a fastener which extends through the seat.

The first and second aerodynamic surfaces may form part of the surface of an aircraft.

### BRIEF DESCRIPTION OF THE DRAWINGS

Embodiments of the invention will now be described with reference to the accompanying drawings, in which:

FIG. 1 is a schematic perspective view, partly in section, of a butt-joint between two adjacent aircraft wing panels;

FIG. 2 is a sectional view showing the joint of FIG. 1 after recesses have been formed in the opposing edges of the panels;

FIG. 3 is a schematic view of an application tool for sealing the gap between the panels of the joint of FIG. 2;

FIG. 4 shows a metrology device measuring the width of the gap;

FIG. 5 shows the joint of FIG. 2 with adhesive applied in the recesses;

FIG. 6 shows a tape sealing the gap between the panels;

FIG. 7 shows an alternative arrangement in which the void under the tape is filled with a filler;

FIG. 8 shows an alternative arrangement in which the void under the tape is filled with adhesive;

FIG. 9 shows an alternative joint with a wider pair of recesses;

FIGS. 10 and 11 illustrate the formation of a scarf joint between a pair of panels; and

FIGS. 12 and 13 illustrate the formation of a joggle joint between a pair of panels.

### DETAILED DESCRIPTION OF EMBODIMENT(S)

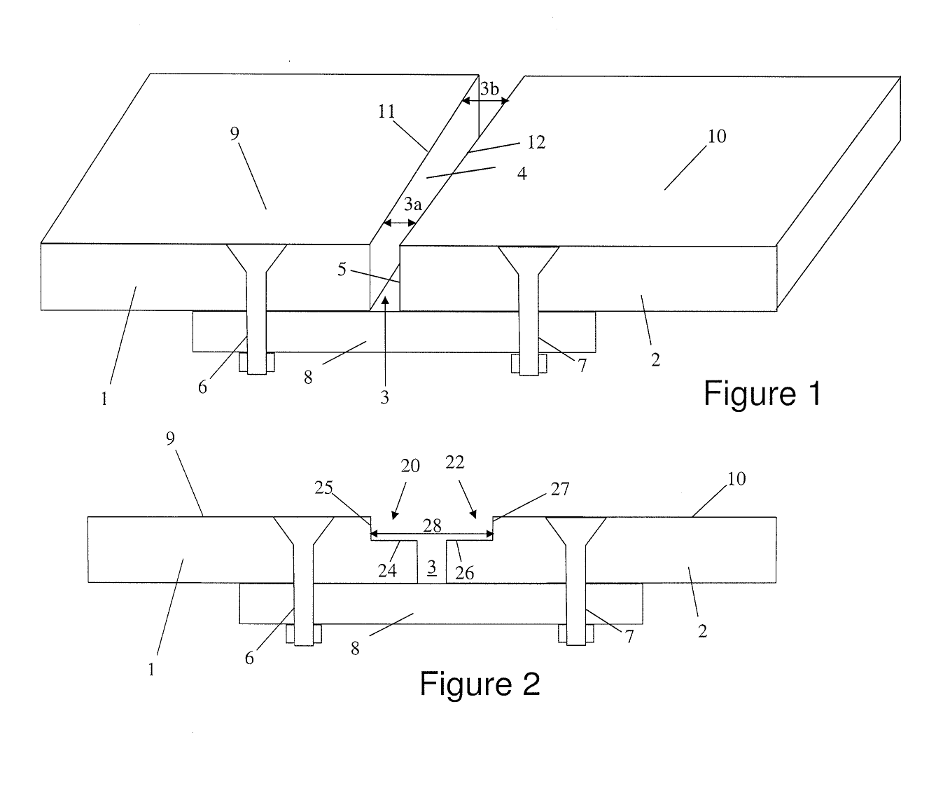

FIG. 1 is a perspective view, partly in section, of a butt joint between adjacent panels 1, 2 which form part of the surface of an aircraft wing. The panels 1, 2 are formed from a composite material, such as (for example) carbon fibre reinforced plastic (CFRP). Due to dimensional tolerances in the manufacture of the panels 1, 2, a void 3 is present between the opposed edges 4, 5 of the panels 1, 2. The width of the void 3 varies along its length: in this case for purposes of illustration the width is shown as increasing uniformly along its length so that it is relatively narrow at one end 3a and relatively wide at the other end 3b, although in practice the width may vary in a more complex or non-uniform manner.

The panels 1, 2 are coupled together by a butt-strap 8 with countersunk fasteners 6, 7. The panels 1, 2 have external aerodynamic surfaces 9, 10 which meet the opposed edges 4, 5 at respective corners 11, 12.

FIGS. 2-6 illustrate a method of sealing the gap between the surfaces 9, 10 in order to optimise the aerodynamic efficiency of the wing.

First, as shown in FIG. 2, the corner 11, 12 of each component is machined to form a recess 20, 22. Each recess has a seat 24, 26 which is substantially parallel with and inset relative to its respective aerodynamic surface 9, 10, and a step 25, 27 between the seat and the aerodynamic surface. The recesses 20, 22 may be formed either before or after the panels 1, 2 have been joined together by the butt-strap 8. The machining process creates an enlarged gap between the aerodynamic surfaces 9, 10 with a width 28 which varies along its length in a similar manner to the un-machined void 3 shown in FIG. 1.

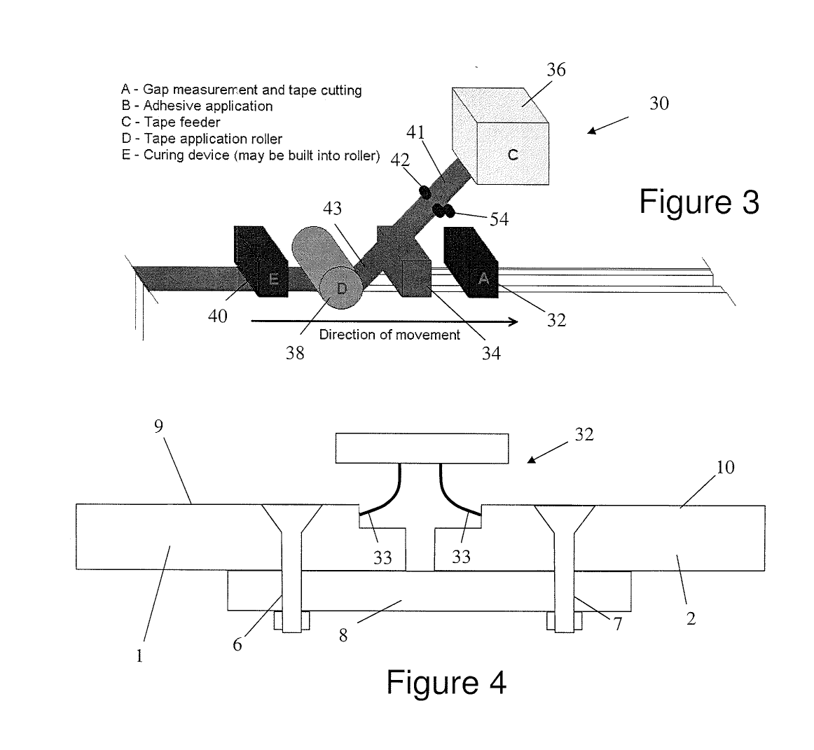

An application tool 30 shown in FIG. 3 is employed to seal this enlarged gap. The application tool 30 comprises a metrology device 32, an adhesive applicator 34, a tape-dispenser 36, an application roller 38 and a curing device 40. The application tool 30 is movable along the entire length of the joint. The tool 30 may be a hand-held unit which is moved manually, or the tool may be moved automatically by a robot arm. In the case where a robot arm is used, then the robot arm may by driven along on rails using the application roller 38 (or another roller) as a driving wheel. Alternatively an overhead rail could be fitted to the wing jig to allow the tool 30 to drive and guide itself along the wing skin.

The metrology device 32 measures the width 28 of the gap between the aerodynamic surfaces 9, 10. As the metrology device 32 moves along the length of the joint, it takes a series of measurements in order to account for its varying width. One preferred implementation of the metrology device 32 is shown in detail in FIG. 4, and comprises a pair of spring-loaded feelers 33 each of which is biased towards a respective one of the opposing panel edges. Alternatively, the metrology device 32 may comprise a laser based measurement system. It will be understood that any other measurement system may be applied.

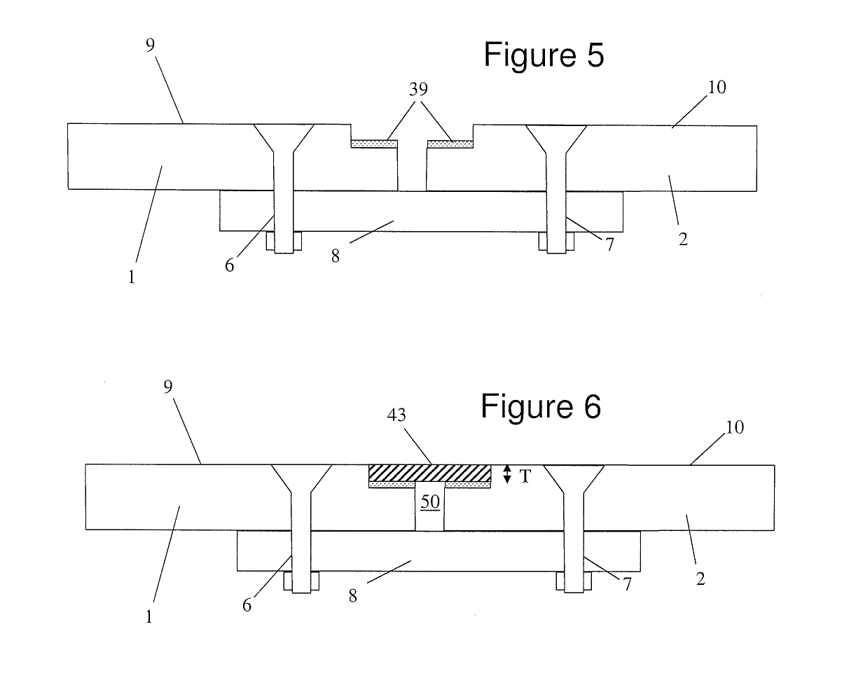

The adhesive applicator 34 follows the metrology device 32 and deposits layers 39 of adhesive onto the seats 24, 26 as shown in FIG. 5. The adhesive may be, for example, acrylic adhesive, epoxy resin adhesive, hot melt adhesive, thermoplastic adhesive, polysulphide adhesive, room temperature vulcanising (RTV) silicone adhesive, or pressure sensitive adhesive.

Aerodynamic smoothing tape 41 is dispensed from a roll within the tape-dispenser 36 by feed rollers 42. As the tape 41 is fed out of the dispenser it is cut by a cutter 54 which trims the width of the tape in accordance with the relevant measurement by the metrology device 32. This continuous adjustment ensures that the width of the tape tapers along its length to accurately correspond with the varying width 28 of the gap. The trimmed tape 43 downstream of the cutter 54 is then pressed onto the seats 24, 26 by the application roller 38 which ensures that the tape is positioned accurately and that it properly engages the adhesive 39.

As shown in FIG. 6, the trimmed tape 43 extends between the aerodynamic surfaces 9, 10 of the panels 1, 2 to accurately seal the gap between them. The thickness T of the tape 43 corresponds with the (well-defined) height of the steps 25, 27 less the adhesive thickness. Thus, the tape 43 lies substantially flush with the aerodynamic surfaces 9, 10.

The tape may be made from, for example, a composite material such as pre-cured glass-fibre reinforced epoxy resin or pre-cured carbon-fibre reinforced epoxy resin, a thermoplastic material such as PEEK (polyaryletheretherketone), a ceramic material, or metallic foil. As the tape is pre-cured and bonded to the panels by an adhesive, it does not need to be cured after application and therefore is not subject to significant shrinkage so it remains substantially flush with the aerodynamic surfaces 9, 10 after. installation.

Finally, the curing device 40 follows the roller 38 to cure the adhesive beneath the tape 43 in order to bond the tape 43 in place. The curing mechanism may be, for example but not exclusively, ultra-violet light, infra-red light, heat or microwave radiation. For example, if the adhesive is an acrylic then the curing mechanism is likely to be ultra-violet light, whereas epoxy resin or polysulphide adhesives will be heated by infra-red or microwave radiation during the cure process.

Depending on the sealant material, the curing function may be integrated into the roller 38. For instance if a metal foil or thermoplastic polymer tape was applied, then the foil or tape could be melted by a hot roller which presses the foil or tape into the gap, followed by a cold roller which cures the foil or tape.

As shown in FIG. 6, a void 50 remains between the tape 43 and the butt-strap 8. As this does not directly affect the aerodynamic performance of the wing, this void may remain unfilled particularly if the void 50 is open at each end to enable water to drain out.

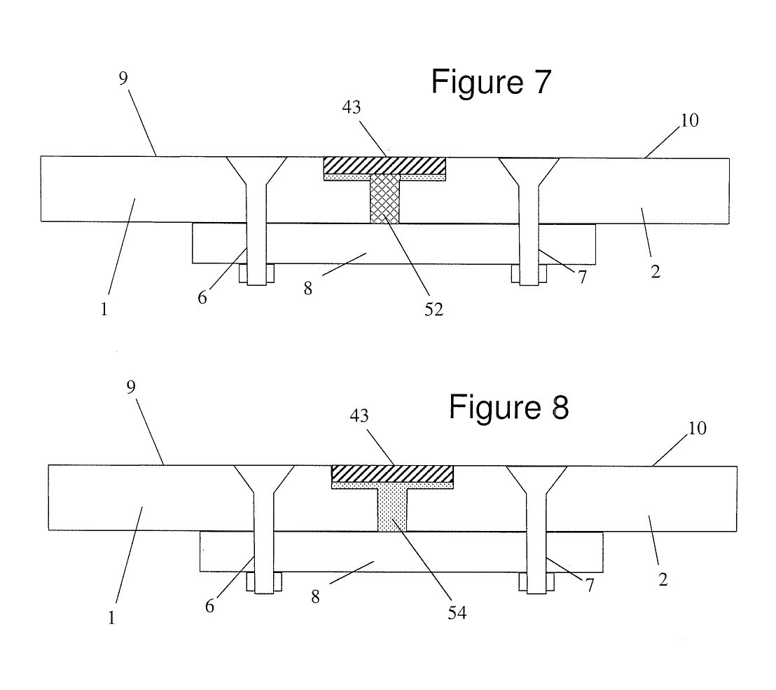

However, optionally the void 50 could be filled to prevent the build-up of water and/or ice in the void 50. For example as shown in FIG. 7, prior to the laying of the tape, a filler 52 may be deposited between the non-machined parts of the opposing edges 4, 5 of the panels 1, 2 in order to fill the void 50. The filler 52 may be a closed cell foam comprising a low density sealant material containing hollow spheres, or an elastomeric foam such as polyurethane foam. Alternatively the filler 52 may be a polysulphide sealant which is gunned into the void 50 in liquid form. Alternatively, instead of using a filler with a different chemical composition to the adhesive, as shown in FIG. 8 the adhesive 54 applied by the adhesive applicator 34 may fill this void 50 as well as covering the seats 24, 26.

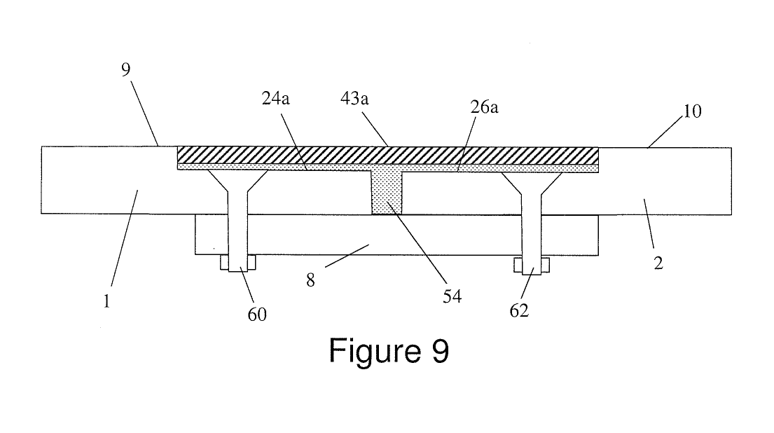

The recesses may be made wider as illustrated in FIG. 9 so that the countersunk fasteners 60, 62 extend through the seats 24a, 26a of the recesses. In this case, as well as sealing the gap between the aerodynamic surfaces 9, 10, the wider tape 43a also covers the heads of the fasteners 60, 62. This has aerodynamic benefits compared with the arrangement of FIGS. 6-8 since, although countersunk, the fasteners 6,7 could still induce a small amount of drag on the wing during use.

The apparatus of FIG. 3 can also be used to seal other types of joint, including scarf joints and joggle joints.

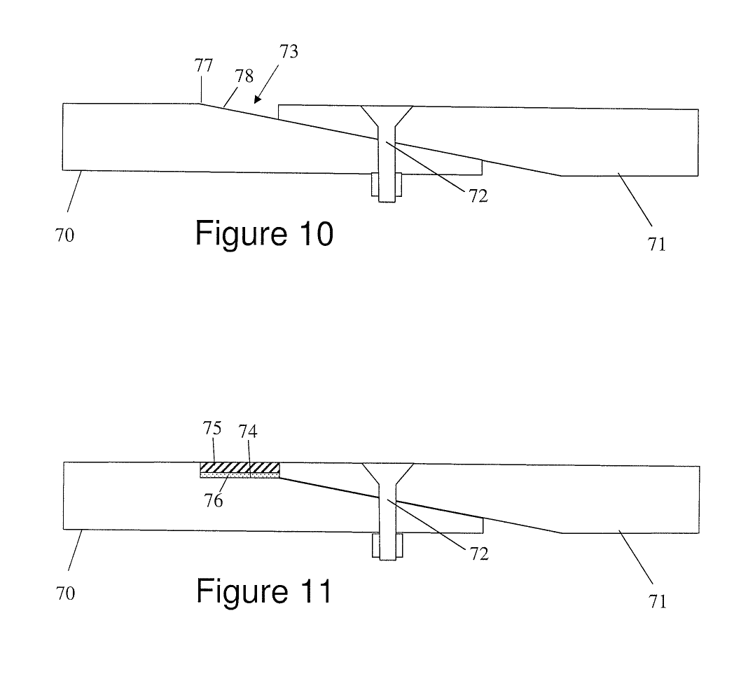

FIGS. 10 and 11 illustrate the formation of a scarf joint between a pair of panels 70, 71. The panels have opposed edges with a gap 73 between them. A recess is machined in a corner 77 where the aerodynamic surface of the left-hand panel 70 meets angled edge 78. The recess has a seat 74 which is inset relative to the aerodynamic surface. The recess is then filled using the apparatus of FIG. 3 with a tape 75. The tape is bonded to the seat 74 of the recess with an adhesive layer 76. Note that in the embodiment of FIG. 11, no recess needs to be formed in the right hand panel 71.

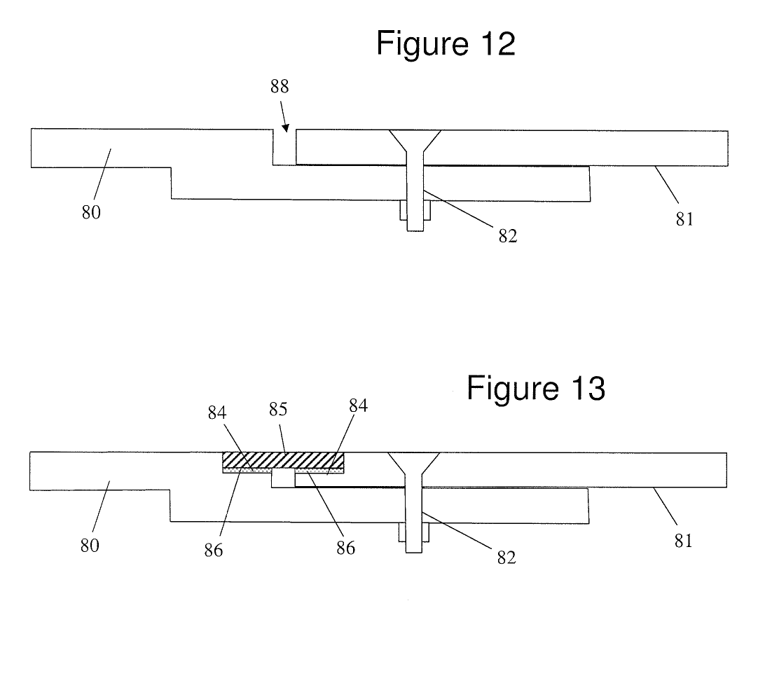

FIGS. 12 and 13 illustrate the formation of a joggle joint between a pair of panels 80, 81 using the apparatus of FIG. 3. A gap 88 between the panels is sealed by forming a pair of recesses in the opposed panel corners, coating the seats 84 of the recesses with adhesive 86, and filling the recesses with a tape 85. The panels 80, 81 are secured together by a fastener 82.

Although the invention has been described above with reference to one or more preferred embodiments, it will be appreciated that various changes or modifications may be made without departing from the scope of the invention as defined in the appended claims.

1. A method of sealing a gap between first and second aerodynamic surfaces, the method comprising: measuring the width of the gap between the two surfaces to obtain a gap measurement; pre-forming the width of a seal member in accordance with the gap measurement; and fitting the seal member into the gap such that the seal member is substantially flush with the first and second aerodynamic surfaces.

2. The method of claim 1 further comprising measuring the width of the gap at a plurality of positions along its length and forming the width of the seal member accordingly.

3. The method of claim 1 wherein the method further comprising: forming a recess in a corner where a first one of the aerodynamic surfaces meets the gap, the recess having a seat which is inset relative to the first one of the aerodynamic surfaces; and engaging the seal member with the seat.

4. The method of claim 3 wherein the method further comprising: forming a second recess in a corner where a second one of the aerodynamic surfaces meets the gap, the second recess having a second seat which is inset relative to the second one of the aerodynamic surfaces; and engaging the seal member with the second seat.

5. The method of claim 3 further comprising bonding the seal member to the seat(s) with an adhesive.

6. The method of claim 3 wherein the (or each) recess is formed by removing material.

7. The method of claim 1 wherein the seal member comprises a curable material which is at least partially cured before sealing the gap.

8. The method of claim 1 wherein the width of the sealing member is pre-formed by removing material from the sealing member.

9. The method of claim 1 further comprising dispensing the seal member from a roll, and cutting the seal member to size in accordance with the gap measurement as it is dispensed from the roll.

10. Apparatus for performing the method of claim 1, the apparatus comprising:
a. a metrology device adapted to measure the width of the gap between the first and second aerodynamic surfaces;
b. a seal member dispenser for dispensing a seal member; and
c. a cutter adapted to cut the seal member to size in accordance with the measurements obtained by the metrology device.

11. The apparatus of claim 10 further comprising: an adhesive applicator.

12. The apparatus of claim 10 wherein the seal member dispenser comprises a roll on which the seal member is wound.

13. An aerodynamic assembly comprising: first and second components with respective first and second aerodynamic surfaces, the first and second components having opposed edges; a gap between the first and second aerodynamic surfaces; and a seal member which extends between the aerodynamic surfaces to seal the gap and is substantially flush with the aerodynamic surfaces, wherein at least one of the components has a recess which is formed in a corner where a respective one of the aerodynamic surfaces meets a respective one of the opposed edges, the recess having a seat which is inset relative to its respective aerodynamic surface and engages the seal member; and
wherein the width of the gap varies along its length and the width of the seal member varies accordingly.

14. The assembly of claim 13 wherein the or each seat is substantially parallel with its respective aerodynamic surfaces.

15. The assembly of claim 13 further comprising an adhesive bonding the seal member to the or each seat.

16. The assembly of claim 13 wherein the components are coupled to each other by a fastener which extends through the seat.

17. The assembly of claim 13 wherein each component has a recess which is formed in a corner where a respective one of the aerodynamic surfaces meets a respective one of the opposed edges, each recess having a seat which is inset relative to its respective aerodynamic surface and engages the seal member.
